(19) United States
(12) Patent Application Publication
(10) Pub. No.: US 2021/0241703 A1
(43) Pub. Date: Aug. 5, 2021

(54) CONTROL DEVICE, DISPLAY DEVICE, AND CONTROL METHOD

(71) Applicant: SHARP KABUSHIKI KAISHA, Sakai City, Osaka (JP)

(72) Inventors: MAKOTO SHIOMI, Sakai City, Osaka (JP); NAOKO GOTO, Sakai City, Osaka (JP); NAOTO INOUE, Sakai City, Osaka (JP); AYA OKAMOTO, Sakai City, Osaka (JP); OSAMU TERANUMA, Sakai City, Osaka (JP); MASAO KURINO, Sakai City, Osaka (JP); YUKI KATSUMURA, Sakai City, Osaka (JP)

(21) Appl. No.: 16/972,561

(22) PCT Filed: May 30, 2019
(86) PCT No.: PCT/JP2019/021474

§ 371 Date: Dec. 4, 2020

(30) Foreign Application Priority Data
Jun. 15, 2018 (JP) 2018-114855

(51) Int. Cl. G09G 3/34; G09G 5/10

(52) U.S. Cl. CPC G09G 3/342; G09G 5/10; G09G 2330/021; G09G 2354/00; G09G 2320/0646

(57) ABSTRACT

To provide a control device capable of reducing power consumption of a display device. A display controller is a control device of a display device including a display including a plurality of light sources to be independently controlled. The display controller performs display processing that involves monitoring an update of an image to be displayed on a screen of the display, and causing a light source corresponding to a display region of the updated image to glow more brightly than another light source, the light source and the other light source being included in the light sources.

### TECHNICAL FIELD

A disclosure below relates to a control device to control how to display an image, a display device including the control device, and a control method for controlling how to display an image.

### BACKGROUND ART

Techniques to reduce power consumption of image display devices performing high-dynamic-range (HDR) rendering are disclosed in such related art documents as Patent Document 1. The invention disclosed in Patent Document 1 limits regions to be subjected to the HDR rendering to a specific region to reduce power consumption. The specific region is, for example, an image region on which a user desires the HDR rendering to be performed.

### CITATION LIST

### Patent Literature

[Patent Document 1] Japanese Unexamined Patent Application Publication No. 2017-045030 (published on Mar. 2, 2017)

### SUMMARY OF INVENTION

### Technical Problem

Unfortunately, Patent Document 1 fails to disclose a technique to reduce power consumption without deteriorating visibility in obtaining information.

An aspect of the present disclosure is intended to provide, for example, a control device capable of reducing power consumption, without compromising visibility in obtaining information displayed on a display device.

### Solution to Problem

In order to solve the above problem, a control device according to an aspect of the present disclosure is of a display device including a display including a plurality of light sources to be independently controlled. The control device performs display processing that involves monitoring an update of an image to be displayed on a screen of the display, and causing a light source corresponding to a display region of the updated image to glow more brightly than another light source. The light source and the other light source are included in the light sources.

A control device according to another aspect of the present disclosure is of a display device including a display including a plurality of light sources to be independently controlled. The control device causes a light source to glow more brightly than another light source. The light source corresponds to a display region, of the display, displaying (i) information input through an operation by a user of the display device or (ii) information related to the information input by the user. The light source and the other light source are included in the light sources.

A control method according to an aspect of the present disclosure is for controlling a display device including a display including a plurality of light sources to be independently controlled. The control method includes display processing that involves monitoring an update of an image to be displayed on a screen of the display, and causing a light source corresponding to a display region of the updated image to glow more brightly than another light source. The light source and the other light source are included in the light sources.

A control method according to another aspect of the present disclosure is for controlling a display device including a display including a plurality of light sources to be independently controlled, the control method includes causing a light source to glow more brightly than another light source. The light source corresponds to a display region, of the display, displaying (i) information input through an operation by a user of the display device or (ii) information related to the information input by the user. The light source and the other light source are included in the light sources.

### Advantageous Effects of Invention

A control device according to an aspect of the present disclosure can reduce power consumption, without compromising visibility in obtaining information displayed on a display device.

### BRIEF DESCRIPTION OF DRAWINGS

FIG. 1 is a block diagram illustrating a configuration of a display device according to a first embodiment.

FIG. 2 includes an illustration (a) for showing an example of image processing using a local dimming function, and a graph (b) showing a grayscale value, of liquid crystal data in the illustration (a), taken along line A-A.

FIG. 3 is a flowchart showing an operation of the display device according to the first embodiment.

FIG. 4 is a block diagram illustrating a configuration of the display device according to the first embodiment.

FIG. 5 is a flowchart showing an operation of a display device according to a second embodiment.

FIG. 6 is a block diagram illustrating a configuration of a display device according to a fourth embodiment.

FIG. 7 is a block diagram illustrating specific configurations of a backlight-data generator and a liquid-crystal-data generator according to the fourth embodiment.

FIG. 8 is a flowchart showing an operation of the display device according to the fourth embodiment.

FIG. 9 is a graph showing backlight brightness with respect to input image brightness, liquid crystal transmittance, and output brightness of the display device according to the fourth embodiment.

FIG. 10 is a block diagram illustrating a configuration of a display device according to a fifth embodiment.

FIG. 11 is a block diagram illustrating configurations of a backlight-data generator, a liquid-crystal-data generator, and a brightness reduction processor according to the fifth embodiment.

FIG. 12 is a graph showing backlight brightness with respect to input image brightness, liquid crystal transmittance and output brightness of the display device according to the fifth embodiment.

FIG. 13 is a graph showing an example of a relationship between brightness of a pixel before processing and brightness of the pixel after processing performed by the brightness reduction processor included in the display device according to the fifth embodiment.

FIG. 14 is a block diagram illustrating other configurations, than those in FIG. 11, of the backlight-data generator, the liquid-crystal-data generator, and the brightness reduction processor according to the fifth embodiment.

FIG. 15 is a flowchart showing processing performed by the display device according to the fifth embodiment.

### DESCRIPTION OF EMBODIMENTS

### First Embodiment

A first embodiment of the present disclosure will be described below in detail.

Configuration of Display Device 1

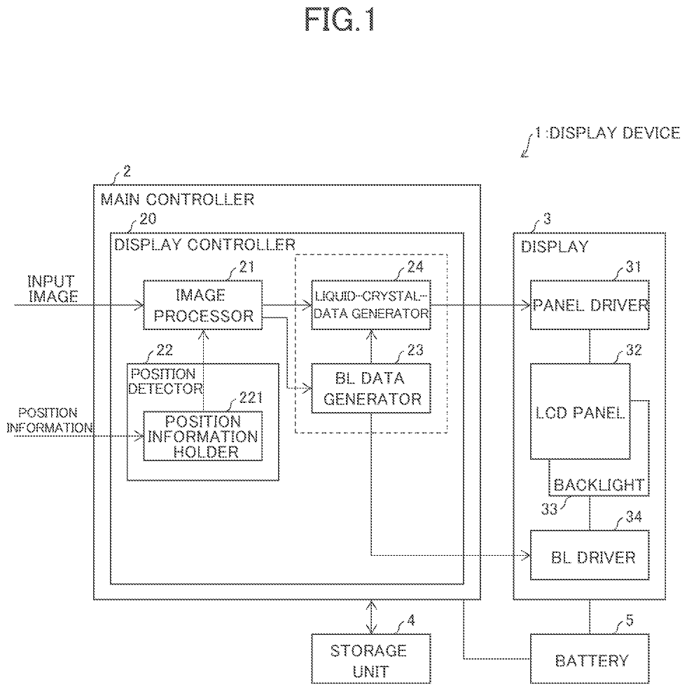

FIG. 1 is a block diagram illustrating a configuration of a display device 1 according to the first embodiment. As illustrated in FIG. 1, the display device 1 displays various kinds of input images. The display device 1 includes: a main controller 2; a display 3; a storage unit 4; and a battery 5. The display device 1 is, for example, a personal digital assistance.

The main controller 2 has overall control of the display device 1. The storage unit 4 stores such data as a program to be processed by the main controller 2. The battery 5 stores power to be supplied to units of the display device 1. That is, the units of the display device 1 are driven by the battery 5.

The display 3 displays an input image processed by a display controller 20. In the first embodiment, the display 3 is a liquid crystal display (LCD). Specifically, the display 3 includes: a panel driver 31; an LCD panel 32; a backlight 33; and a backlight driver 34. Note that, in the drawings, the term “backlight” is also denoted as “BL.”

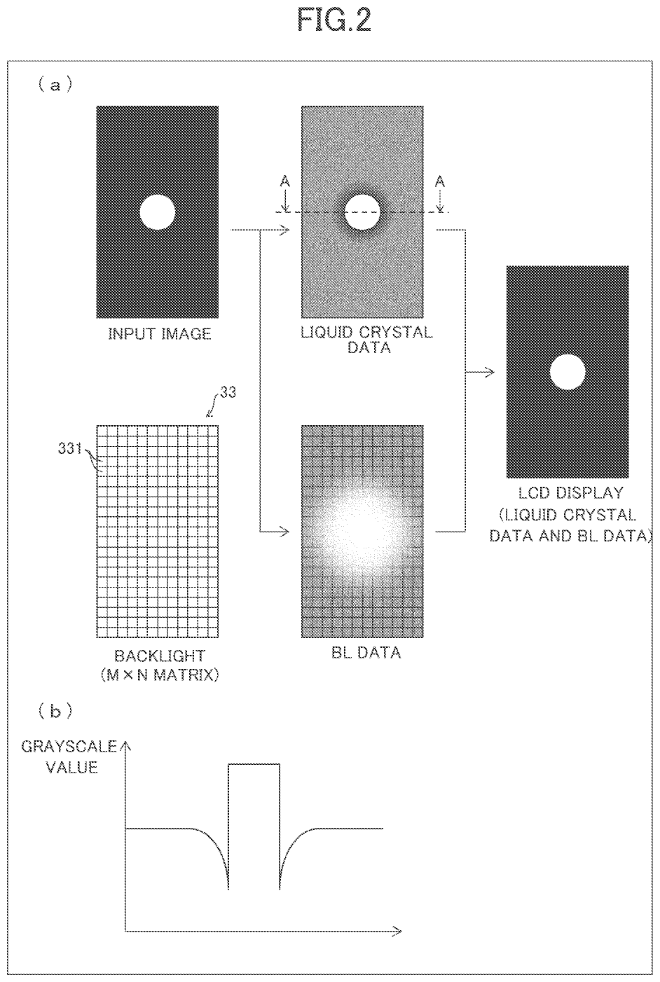

The panel driver 31 controls to drive the LCD panel 32 in accordance with liquid crystal data based on the input image processed by the display controller 20 (a control device). The LCD panel 32 displays the processed input image. The backlight 33 includes a plurality of light sources 331 (see FIG. 2) to be independently controlled. The backlight driver 34 causes the backlight 33 to glow in accordance with backlight data based on the input image processed by the display controller 20.

The main controller 2 includes the display controller 20 to control the display 3. While executing a predetermined application, the display controller 20 performs display processing. The display processing involves monitoring an update of an image to be displayed on a screen of the display 3, and causing a light source 331, of the backlight 33, corresponding to a display region (an updated region) of the updated image to glow more brightly than another light source 331. In other words, the display controller 20 causes a light source 331 corresponding to a region other than the updated region (a non-updated region) to glow less brightly than the light source 331 corresponding to the updated region.

A region to be displayed with its brightness maintained the same as that of the corresponding region of the input image is referred to as a bright region. A region to be displayed with its brightness decreased below that of the corresponding region of the input image is referred to as a dark region. The dark region is a display region having brightness lower than or equal to a predetermined value. Usually, the bright region is higher in brightness than the dark region.

Note that when a predetermined time period elapses after the update of the image, the display controller 20 causes the light source 331, of the backlight 33, corresponding to the updated region to glow with the same brightness as before the update of the image (that is, to cause the light source 331 to glow as the dark region). The time period to display the updated region as the bright region may be set as appropriate. An example of such a time period may be 15 seconds.

Moreover, a region in which a cursor for entering text is displayed is assumed to attract attention of a user. Hence, the display controller 20 may assign an area around the cursor as the bright region.

In personal digital assistances of recent years, images displayed on their screens contain a lot of information. However, except for a case of switching and viewing pictures, or reproducing a video, for example, a region of an image to be displayed on the screen and actually viewed at a given moment by a user is often a part of a region recently updated before the given moment.

What makes the screen updated differs depending on applications executed by the display device 1. The first embodiment shows as an example of a case where the screen is updated to present the user a notice from a system or an application. The first embodiment involves decreasing brightness of the non-updated region in the input image to reduce power consumption.

Local Dimming Function

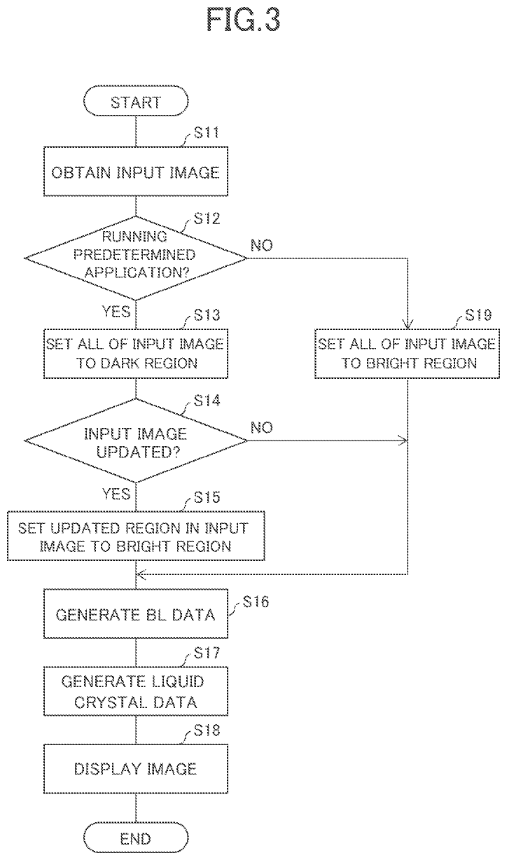

In the first embodiment, image display processing is performed, using a local dimming function. In the local dimming function, the display region of the LCD 32 is divided into a matrix, and each of the light sources 331 of the backlight 33 is controlled to glow for a corresponding one of the divided sub-regions (namely, local areas, or blocks). Described here with reference to illustrations (a) and (b) in FIG. 2 is an example of image processing performed on the local dimming function. The illustration (a) in FIG. 2 shows an example of the image processing. The illustration (b) in FIG. 3 is a graph showing a grayscale value, in the illustration (a) of FIG. 3, taken along line A-A. In the illustration (b) of FIG. 3, the horizontal axis and the vertical axis respectively represent a position and a grayscale value on the line A-A.

In an input image in the illustration (a) of FIG. 2, a region outlined in white is higher in brightness than the rest of the region. Furthermore, the display region of the LCD panel 32 (i.e., the backlight 33 corresponding to the display region) is divided into the sub-regions (an m×n matrix). The illustration (a) of FIG. 2 shows that the backlight 33 is divided into m×n sub-regions. Each of the sub-regions includes one of the light sources 331. Note that each sub-region may include two or more of the light sources 331.

When the local dimming function is used to process an image as shown in the illustration (a) of FIG. 2, backlight data to control brightness of the backlight 33 is generated in accordance with a brightness value (or a pixel value) of the input image. Specifically, the input image is divided into regions each corresponding to one of the sub-regions. In accordance with a brightness value of the divided region, determined as the backlight data is a light-source brightness value of each light source 331 included in a corresponding one of the sub-regions of the backlight 33. In the first embodiment, the backlight data is generated by a backlight-data generator 23.

In accordance with the backlight data and the brightness values of the input image, liquid crystal data to control the LCD panel 32 is generated. Specifically, brightness distribution of the backlight 33 is calculated in accordance with the backlight data and a brightness spread function (i.e., a point spread function, or PSF) which is data representing how light spreads in values. Each of the brightness values (normalized values) of the input image is divided by a corresponding one of brightness values (normalized values) for brightness distribution of the backlight 33, thus determining an output value (a liquid crystal transmittance) for each pixel of the LCD panel 32. As data to indicate this output value, the liquid crystal data shown in the illustration (b) of FIG. 2 is generated. In the first embodiment, the liquid crystal data is generated by a liquid-crystal-data generator 24.

The panel driver 31 drives the LCD panel 32 with the output values indicated in the liquid crystal data, and, simultaneously, the backlight driver 34 causes the backlight 33 to glow with the light-source brightness values indicated in the backlight data. This is how the LCD 32 displays the input image.

In the first embodiment, the backlight-data generator 23 and the liquid-crystal-data generator 24 respectively generate the backlight data and the liquid crystal data using not only the input image but also a processed image to be described later.

Details of Display Controller 20

As illustrated in FIG. 1, in order to perform the above display processing, the display controller 20 includes: an image processor 21; a position detector 22; the backlight-data generator 23; and the liquid-crystal-data generator 24. The backlight-data generator 23 and the liquid-crystal-data generator 24 have the local dimming function, and act as an LCD controller to directly control the display 3 as an LCD.

The image processor 21 decreases the brightness of all of the input image to generate a processed image. Note that, when the updated region is found in the input image, the image processor 21 decreases the brightness of the non-updated region alone to generate the processed image.

In the first embodiment, the image processor 21 sets all of the screen of the display 3 to a dark region while the display device 1 is running a predetermined application. Specifically, the image processor 21 decreases (e.g., halves) the brightness of all of the input image. Note that, if the input image includes the updated region, the image processor 21 sets the updated region to a bright region. That is, if detecting the update of the image when all the screen of the display 3 is set to the dark region, the image processor 21 maintains the brightness of the updated region in the input image. In other words, the image processor 21 decreases brightness of a part, of the input image, to be displayed in the dark region.

As a result, the brightness of a light source 331 corresponding to the dark region decreases, and a light source 331 corresponding to the updated region glows relatively brighter than a light source 331 corresponding to the non-updated region.

The position detector 22 detects position information indicating a position of the updated region. In the first embodiment, the position detector 22 obtains information on the update of an image from a base system of the display device 1 or an application (i.e., an application issuing an input image) installed in the display device 1. An example of the input image to be updated includes a presentation of a pop-up window (that may be either for the user to enter information, or for simply presenting information to the user). Most of the applications use a regular call of the system (i.e., a function included in the system) to achieve such a function. The position detector 22 monitors use of the regular call to obtain the update information. The update information on the image includes the position information on the updated region. The position detector 22 obtains the update information on this image to detect a position of the updated region.

Moreover, the position detector 22 includes a position information holder 221 temporality holding the obtained position information. The position information holder 221 transmits the position information to the image processor 21 when the image processor 21 receives the input image corresponding to the obtained position information. The position information holder 221 can provide the position information to the image processor 21 when the image processor 21 processes the input image. Note that the position information holder 221 is not necessarily essential if (i) the position information can be provided to the image processor 21 in processing the input image, or (ii) the image processor 21 can hold the position information.

The backlight-data generator 23 generates backlight data in accordance with the image processed by the image processor 21 (i.e., a processed image). That is, the backlight-data generator 23 generates the backlight data so that a light source 331 corresponding to the updated region glows more brightly than another light source 331 (i.e., a light source 331 corresponding to the dark region).

The liquid-crystal-data generator 24 generates liquid-crystal data in accordance with the image processed by the image processor 21 (i.e., a processed image), and the backlight data generated by the backlight-data generator 23.

Hence, because the backlight data generator 23 and the liquid-crystal-data generator 24 respectively generate the backlight data and the liquid crystal data in accordance with the display position detected by the position detector 22, the display controller 20 can perform the above display processing in accordance with the display position.

Operation of Display Device 1

FIG. 3 is a flowchart showing an operation of the display device 1. In the flowchart below, the screen is to be updated by a predetermined application.

In the display device 1, first, the image processor 21 obtains an input image (S11). Next, the image processor 21 determines whether the display device 1 is running a predetermined application (S12). If the display device 1 is running the predetermined application (YES at S12), the image processor 21 sets all of the input image to a dark region (S13). Specifically, the image processor 21 decreases the brightness of all of the input image. If the position detector 22 obtains position information indicating a position of an updated region (YES at S14), the image processor 21 generates, in accordance with the position information obtained by the position detector 22, a processed image in which the updated region alone is a bright region (S15).

After that, in accordance with the generated processed image, the backlight data generator 23 generates backlight data (S16), and the liquid-crystal-data generator 24 generates liquid crystal data (S17). The display 3 displays an image, using the generated backlight data and liquid crystal data (S18).

Thanks to the above processing flow, the light source 331 corresponding to the updated region glows in normal brightness, and the light source 331 corresponding to the non-updated region glows less brightly than the light source 331 corresponding to the updated region. Such a feature makes it possible to reduce power consumption of the display device 1, without deteriorating visibility of the information displayed in the updated region.

Note that, if the display device 1 is not running the predetermined application (NO at S12), the image processor 21 does not change the brightness of the input image, and sets all of the input image to a bright region (S19). After that, the processing in the above steps S16 to S18 is executed. Moreover, if the display device 1 is running the predetermined application and no updated region is found (NO at S14), the step S15 is skipped and the processing in steps S16 to S18 is executed.

Furthermore, if the display device 1 is not running the predetermined application (NO at S12), the image processor 21 may set all of the input image to a dark region. Such processing may be executed especially when, for example, the display device 1 has to reduce its power consumption.

### Second Embodiment

A second embodiment of the present disclosure will be described below.

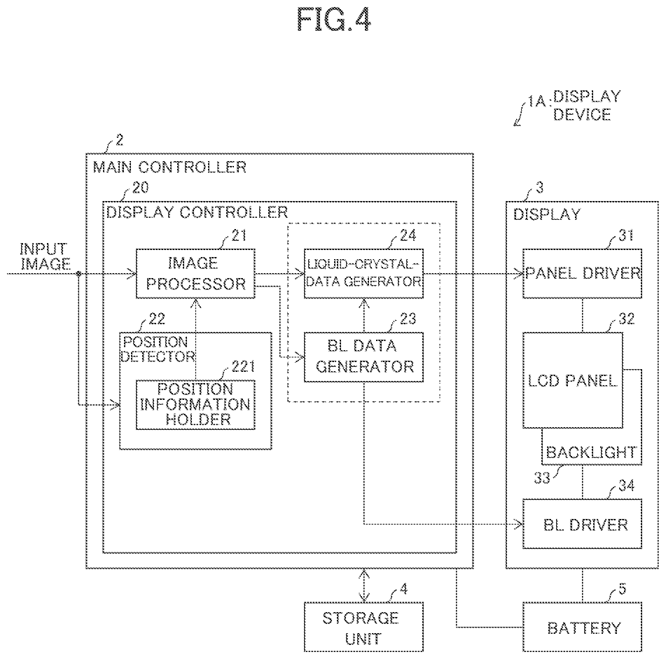

FIG. 4 is a block diagram illustrating a configuration of a display device A according to the second embodiment. As illustrated in FIG. 4, in the display device 1A, an input image is provided to both the image processor 21 and the position detector 22. Moreover, the position detector 22 in the second embodiment does not receive position information, indicating a position of an updated region in the input image, from the outside of the main controller 2.

In the second embodiment, the position detector 22 identifies an area to display information (i.e., a letter) input through, for example, a user operation. Specifically, for example, the display device 1A includes a not-shown frame memory to redraw a displayed screen for each update of the frame. The position detector 22 compares input images between frames. If the input images include a region whose change in pixel value between the input images is greater than or equal to a predetermined threshold, the position detector 22 identifies the region as the updated region. In such a case, the frame memory preferably stores an average value of the pixel values to be included in certain individual regions in the input image in order to save capacity of the frame memory.

Moreover, the position detector 22 may obtain from an application such information as a position in which a command button is touched when an edit region is tapped and scrolled, and a current position of the cursor, and may estimate a position of the updated region in accordance with the obtained information.

While the display device 1A is running a predetermined application, the image processor 21 sets all of the screen of the display 3 to a dark region. In this state, when the position detector 22 detects the updated region, the image processor 21 raises the brightness of the updated region in the input image higher than that of a non-updated region in the input image. Specifically, if the updated region is found, the image processor 21 sets the updated region to a bright region.

In the second embodiment, the information displayed in the updated region (i.e., a region updated by a user operation) is assumed to be essential for the user using the display device 1A. On the basis of this assumption, the second embodiment involves decreasing brightness of the non-updated region while maintaining brightness of the updated region to reduce power consumption.

A predetermined application in the second embodiment includes an application for texting a short sentence (to fit in one screen) or an e-mail message, or organizing a schedule. Such an application displays information input by the user or information related to the information input by the user (i.e., a letter converted after input) to update an image. The image processor 21 determines a display region to be newly displayed by a user operation as a bright region.

Moreover, in the application, the image displayed on the screen of the display 3 could change in position or size depending on an input operation by the user. In such a case, the image processor 21 may determine the display region of the changed image as the bright region. Furthermore, in such a case, as seen in the first embodiment, the position detector 22 may obtain the update information on the changed image from the system or the application.

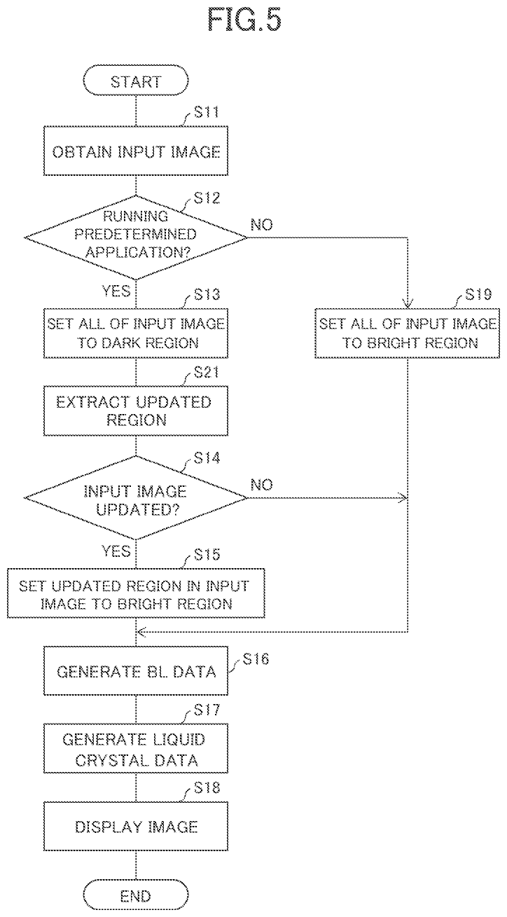

FIG. 5 is a flowchart showing an operation of the display device 1A according to the second embodiment. The only difference between the operation of the display device 1A according to the second embodiment and that of the display device 1 according to the first embodiment is that, in the former operation, Step S21 is executed between Steps S13 and S14.

In the display device 1A according to the second embodiment, the image processor 21 sets all the input image to a dark region at Step S13. After that, the position detector 22 extracts an updated region of the input image (S21). If the updated region is found (YES at S14), the display controller 20 executes processing subsequent to Step S15.

### Third Embodiment

A third embodiment of the present disclosure will be described below. A configuration of a display device according to the third embodiment, which is the same as that of the display device 1A according to the second embodiment, will be described with reference to FIG. 4.

While the display device 1A is running a predetermined application, the image processor 21 in the third embodiment also sets all of the screen of the display 3 to a dark region. Note that the predetermined application in the third embodiment clips a part of a large image (content data) as a whole. An example of such an application includes a map application, an application for texting a long sentence (not to fit in one screen), or an application to display a log of an operation of any given electronic device.

Such an application contains a function to scroll the whole screen by such a user operation as a swipe gesture or a pinch gesture in order to assist an access of the user to information out of the displayed area. When all the screen is scrolled, the whole screen is updated as a displayed image. Hence, for example, in the display device 1A of the second embodiment, the whole screen is a bright region.

When all the screen is scrolled, however, most of the region of the updated screen displays, in a different position, an image indicating the same information displayed before the update. The only region to display an image indicating new information is a region on an end of the updated screen.

The position detector 22 detects a user operation on the display device 1A. When detecting an operation to scroll all the screen, the position detector 22 obtains from the system a direction in which the screen has moved by the scroll, and identifies a position of a region to display an image showing new information.

In accordance with the position, of the region to show the new information, identified by the position detector 22, the image processor 21 sets the region to a bright region. Hence, the image processor 21 causes a light source 331 corresponding to a part, of content, to be newly displayed by a user operation to glow more brightly than a light source 331 corresponding to a part, of the content, already displayed.

A flowchart showing an operation of the display device 1A according to the third embodiment is the same as those showing the operations of the display devices 1 and 1A according to the first and second embodiments. Note that, in the display device 1A according to the third embodiment, position information as information on the updated region is obtained from the position detector 22 in Step S14. The position information indicates a position of a region showing new information.

Note that the position detector 22 may identify only the direction in which the screen has moved by the scroll. In such a case, the image processor 21 may set an end of an input image (e.g., a lower end of the screen if the screen is scrolled up) to a bright region because the end is expected to display new information. Moreover, the position detector 22 may identify only the fact that the screen has moved by the scroll. In such a case, a part of the screen (any one of an upper end, a center, or a lower end of the screen) is set to a bright region, such that the user can obtain information on the whole content by following the bright region.

If the updated region of an image displayed by an application covers a wide area in such a case where all the screen is scrolled, it is preferable to previously designate a special technique to be used for the application. For example, if the application is of a game, a level of importance is unknown for a region to be redrawn in an image, and the image changes drastically. In such a case, the updated region to be displayed as the bright region is presented for a long time period, making it possible to reduce the risk that the user might overlook the information to be displayed in the updated region.

### Fourth Embodiment

A fourth embodiment of the present disclosure will be described below.

In the display devices 1 and 1A according to the first embodiment and the second and third embodiments, the image processor 21 decreases brightness of a non-updated region in an input image, or of a region other than the region showing new information in the input image. In contrast, a display device 1B of the fourth embodiment generates backlight data to decrease an upper limit of brightness of a light source 331 corresponding to a display region in which brightness decreases, and to keep the light source 331 corresponding to the display region from glowing more brightly than the upper limit.

The fourth embodiment describes a specific example in which this technique to reduce power consumption is applied to the display device 1A of the second embodiment. As seen in the second embodiment, in the fourth embodiment, the information displayed in the updated region is assumed to be essential for the user using the display device 1B. On the basis of this assumption, the fourth embodiment involves setting brightness of the light source 331, corresponding to the non-updated region, to an upper limit or below to reduce power consumption.

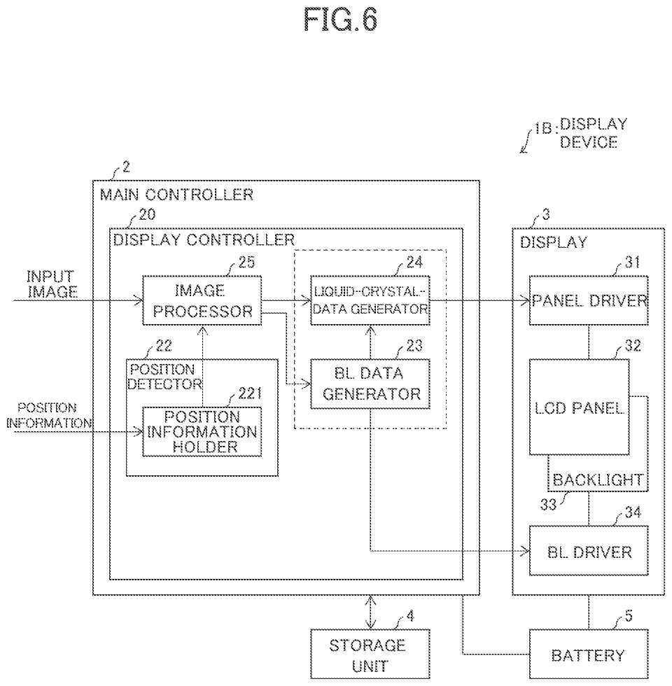

FIG. 6 is a diagram illustrating a configuration of the display device 1B according to the fourth embodiment. As illustrated in FIG. 6, the display device 1B includes a region information generator 25 instead of the image processor 21.

The region information generator 25 applies the above the power consumption reduction technique to the non-updated region, but not to the updated region. A display region to which the power consumption reduction technique is applied is referred to as a low brightness region, and a region to which the power consumption reduction technique is not applied is referred to as a bright region. The low brightness region is a display region to display a part of an input image when the part is displayed with its brightness decreased to be lower than the original brightness of the input image. The low brightness region is the same in advantageous effect as the above dark region in that the part of the input image is displayed consequently with lower brightness than that of the input image. The low brightness region is displayed with its brightness lower than or equal to a predetermined value.

Specifically, the region information generator 25 determines the bright region and the low brightness region in accordance with a position of an updated region detected by the position detector 22, and outputs an input image and data indicating the bright region and the low brightness region to the backlight-data generator 23. If the brightness, of the light source 331 corresponding to the low brightness region, determined in accordance with the input image is higher than the predetermined upper limit, the backlight-data generator 23 of the fourth embodiment generates backlight data in which the brightness is decreased to the predetermined upper limit.

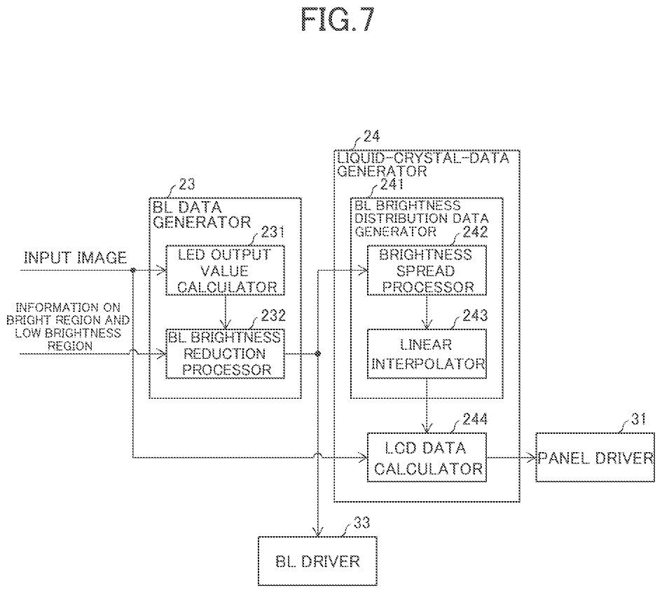

FIG. 7 is a block diagram illustrating specific configurations of the backlight-data generator 23 and the liquid-crystal-data generator 24 according to the fourth embodiment. As illustrated in FIG. 7, the backlight-data generator 23 includes: an LED output value calculator 231; and a BL brightness reduction processor 232. The liquid-crystal-data generator 24 includes: a BL brightness distribution data generator 241; and an LCD data calculator 244.

The LED output value calculator 231 calculates output values (brightness) of the light sources 331 for the regions of the backlight 33 in accordance with a brightness value of an input image, and outputs the calculated output values to the BL brightness reduction processor 232. If brightness of a light source 331 corresponding to a low brightness region is higher than a predetermined upper limit, the BL brightness reduction processor 232 decreases the brightness to the predetermined upper limit. The data indicating the corrected output value of the light source 331 is output as the backlight data to the backlight driver 34 and the liquid-crystal-data generator 24.

Note that the BL brightness reduction processor 232 may use another technique to correct brightness of a light source 331. For example, the BL brightness reduction processor 232 may set, for brightness of a light source 331, the predetermined upper limit and a threshold smaller than the upper limit. The BL brightness reduction processor 232 may then correct brightness, of a light source 331, exceeding the threshold by reducing the brightness within a range from the threshold to the upper limit. Moreover, the BL brightness reduction processor 232 may correct brightness of the light source 331 corresponding to a low brightness region by multiplying the brightness value of the light source 331 by a factor larger than or equal to 0 and smaller than or equal to 1. In such a case, the above factor may be (i) a constant value independent from the brightness of the light source 331, and (ii) a value variable, depending on the brightness of the light source 331, in accordance with a predetermined function (or a value incrementally variable).

The BL brightness distribution data generator 241 includes: a brightness spread processor 242; and a linear interpolator 243. The brightness spread processor 242 calculates data of brightness distribution among individual light sources 331 in accordance with an output value of an LED and a predetermined brightness point spread function (PSF). The liner interpolator 243 linearly interpolates the data of brightness distribution among the individual light sources 331 to calculate data of brightness distribution throughout the backlight 33. The LCD data calculator 244 calculates liquid crystal data in accordance with the data of brightness distribution throughout the backlight 33 and with an input image. The LCD data calculator 244 outputs the calculated liquid crystal data to the panel driver 31.

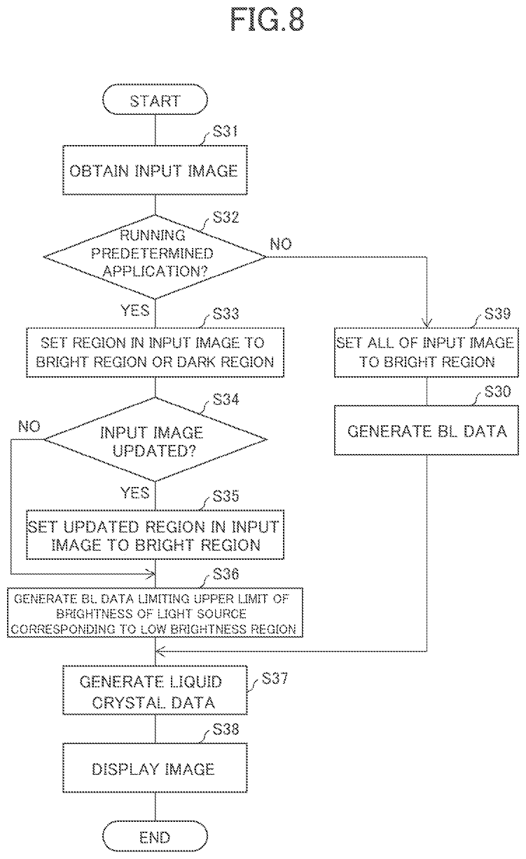

FIG. 8 is a flowchart showing an operation of the display device 1B.

In the display device 1B, first, the region information generator 25 obtains an input image (S31), and determines whether the display device 1B is running a predetermined application (S32). If the display device 1B is running the predetermined application (YES at S32), the region information generator 25 sets a region included in the input image to a bright region or a dark region in accordance with information initially set for the predetermined application (S33). Setting to a bright region or to a dark region in the fourth embodiment is different from that in the first embodiment in that the former setting involves generating information to identify the region as a bright region.

If obtaining position information indicating a position of an updated region (YES at S34), the region information generator 25 sets a non-updated region in the input image to a low brightness region (S35). Specifically, the region information generator 25 generates information (low-brightness-region identification information) to identify the position of the non-updated region, in the input image, to be displayed as the low brightness region.

After that, the backlight data generator 23 generates backlight data in accordance with the input image and the low-brightness-region identification information (S36). Specifically, in the backlight data generator 23, the LED output value calculator 231 calculates output values of the light sources 331, and then the BL brightness reduction processor 232 reduces brightness of a light source 331, corresponding to the low brightness region, to a predetermined upper limit. Moreover, the liquid-crystal-data generator 24 generates liquid crystal data in accordance with the input image and the backlight data (S37). The display 3 displays an image, using the generated backlight data and liquid crystal data (S38).

If the display device 1B is not running the predetermined application (NO at S32), the region information generator 25 sets all of the input image to a bright region (S39), and generates backlight data (S30). After that, the processing in the above steps S37 and S38 is executed. Moreover, if the display device 1B is running the predetermined application and no updated region is found (NO at S34), the step S35 is skipped and the processing in steps S36 to S38 is executed.

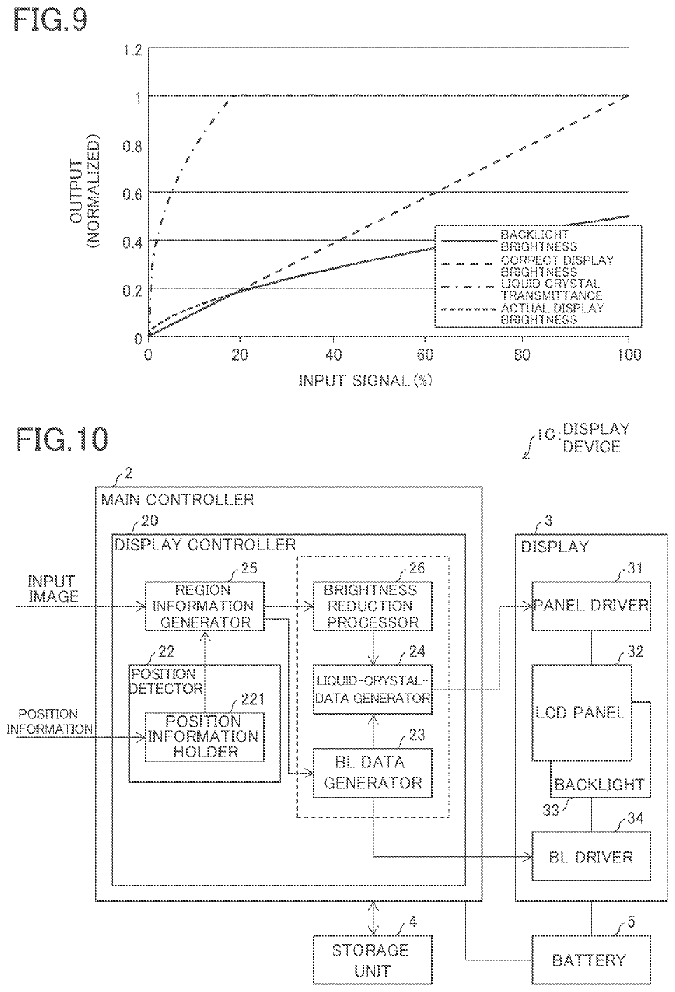

FIG. 9 is a graph showing backlight brightness with respect to input image brightness, liquid crystal transmittance, and output brightness of the display device 1B.

As illustrated in FIG. 9, the brightness of the backlight 33 in the display device 1B is reduced to half of the normal brightness at most. In the display device 1B, when the input image has a brightness of approximately 18%, the brightness of the backlight 33 is equal to that of the input image. Hence, the liquid crystal transmittance is 1. When the brightness of the input image exceeds approximately 18%, the brightness of an output image falls below that of the input image. In such a case, representation of grayscale brightness depends on backlight brightness. That is why the grayscale brightness is represented poorly. The poor grayscale brightness is otherwise a cause of a poor image. In the fourth embodiment, however, the information to be displayed in the low brightness region is basically not important for the user. Hence, the information to be displayed in the low brightness region does not have to be displayed using a complex grayscale pattern. Hence, in many cases, this limitation of the brightness does not cause a faulty image. Note that the brightness of 18% is an example determined by a test pattern for evaluating the brightness, and is variable depending on an actual usage environment of the display device 1B. Examples of the usage environment include: a pattern of the input image; an area of a low brightness region; a positional relationship between the low brightness region and a high brightness region; an average brightness of the high brightness region; and a backlight brightness, of the high brightness region, related to the average brightness.

As can be seen, in the display devices 1 and 1A of the first and second embodiments, the image processor 21 decreases brightness, of an input image, corresponding to a non-updated region. As a result, brightness of the backlight 33 corresponding to the non-updated region decreases, reducing power consumption of the display device 1A.

In contrast, in the display device 1B, brightness of a light source 331 corresponding to the non-updated region has an upper limit, and the backlight data generator 23 causes the light source 331 not to glow more brightly than the upper limit. This is how the display device 1B reduces its power consumption.

In setting the upper limit of the backlight brightness (the brightness of the light source 331), for example, an amount of power to be consumed by the display device 1A may be determined, and the upper limit may be set to correspond to the determined power consumption.

Furthermore, in setting the upper limit of the backlight brightness, for example, an upper limit may be determined for the brightness of a display image whose grayscale representation is desirably maintained. Accordingly, the upper limit of the backlight brightness may be set to correspond to the upper limit of the brightness of the display image. In such a case, for a pixel, of the pixels included in the dark region, whose brightness in the input image is lower than or equal to the above upper limit, the brightness of the display image can be controlled with the liquid crystal transmittance. Hence, the brightness can be controlled precisely.

Note that, in the display devices according to an aspect of the present disclosure, the image processor 21 of the first embodiment and the backlight data generator 23 of the fourth embodiment may be used in combination. That is, the image processor 21 may decrease the brightness of the input image, and then, the backlight data generator 23 may decrease the backlight brightness in the backlight data.

Moreover, the technique to reduce power consumption according to the fourth embodiment may be applied to the display device of the first embodiment.

### Fifth Embodiment

A fifth embodiment of the present disclosure will be described below.

FIG. 10 is a block diagram illustrating a configuration of a display device 1C according to the fifth embodiment. As illustrated in FIG. 10, in addition to the constituent features of the display device 1B, the display device 1C further includes a brightness reduction processor 26.

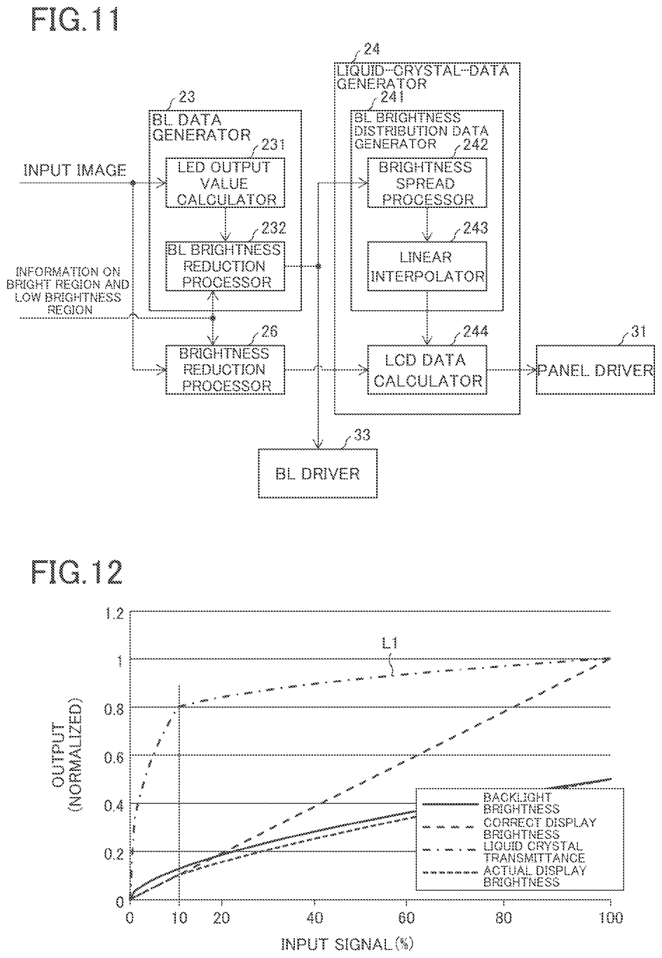

FIG. 11 is a block diagram illustrating configurations of the backlight-data generator 23, the liquid-crystal-data generator 24, and the brightness reducing processor 26 according to the fifth embodiment. The brightness reduction processor 26 receives an input image, backlight data, and information on a bright region and a low brightness region, and then reduces brightness of some of pixels of the input image to generate a processed image.

As illustrated in FIG. 9, in the case where the brightness of the backlight 33 is decreased to 50%, and the liquid crystal data is generated in accordance with the brightness value of an input image, the input signal strength (e.g., the grayscale value) of the input image is 18% of the maximum strength, and the liquid crystal transmittance is 100%. Hence, when the liquid crystal transmittance reaches 100% in the case where the backlight brightness has the upper limit and the input image is displayed as it is, and the liquid crystal transmittance does not increase depending on the brightness of the pixels of the input image, such a situation is referred to as “the liquid crystal transmittance is saturated.” When the liquid crystal transmittance is saturated, the liquid crystal cannot provide fine grayscale representation. As described before, when the display device 1 is used under normal conditions, the saturation of the liquid crystal transmittance does not cause a serious problem to an image. Depending on a usage of the display device 1, however, it can be highly likely that maintaining the information on the grayscale is preferable.

Hence, for a pixel, of an input image, whose liquid crystal transmittance is higher than or equal to a predetermined value (except for a pixel having the maximum brightness), the brightness reduction processor 26 decreases the brightness of the pixel in a predetermined manner to keep the liquid crystal transmittance from reaching 100% not to saturate the liquid crystal transmittance. The above predetermined value may be, for example, 80%. In the example illustrated in FIG. 9, the input signal strength of the input image is approximately 15%, and the liquid crystal transmittance is 80%.

FIG. 12 is a graph showing backlight brightness with respect to input image brightness, liquid crystal transmittance, and output brightness of the display device 1C. For a pixel, in a low brightness region of the input image, with an input signal strength of 15% or greater, the brightness reduction processor 26 decreases the brightness of the pixel and generates a processed image. A curve L1 in FIG. 12 shows a relationship between the input signal strength and the liquid crystal transmittance of the processed image. That is, the brightness reduction processor 26 decreases the brightness of each pixel in the low brightness region of the input image so that the relationship between the input signal strength and the liquid crystal transmittance of the processed image is represented by the curve L1 (i.e., a predetermined relationship).

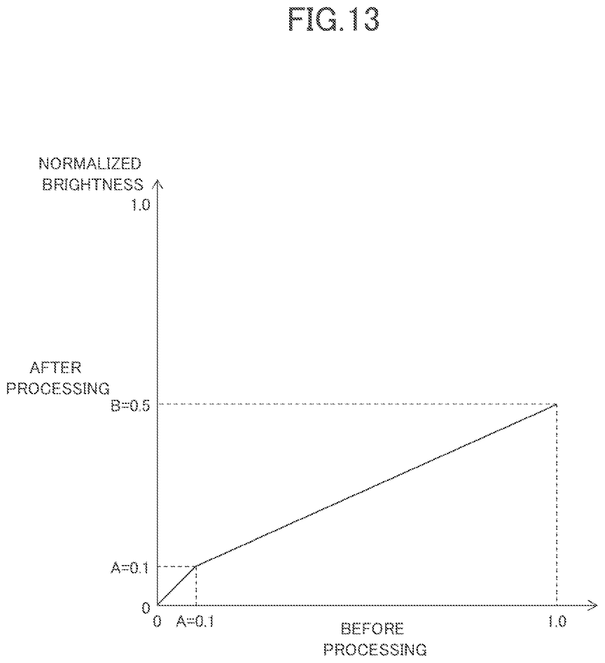

FIG. 13 is a graph showing an example of a relationship between brightness of a pixel before processing and brightness of the pixel after processing performed by the brightness reduction processor 26 included in the display device 1C. For example, the brightness reduction processor 26 decreases brightness of a pixel in a low brightness region of an input image so that the brightness of the pixel before processing and the brightness of the pixel after processing represent the relationship illustrated in the graph of FIG. 13. More specifically, the brightness reduction processor 26 applies: an expression (1) below if the brightness of the pixel before processing is 0 or higher and A or lower; and an expression (2) below if the brightness of the pixel before processing is higher than A and 1 or lower.

y=x (1)

$$\begin{matrix}[ Math . 1 ] & \\ y = \frac{A - B}{A - 1} x + A \frac{B - 1}{A - 1} & ( 2 )\end{matrix}$$

The processing using the expressions (1) and (2) is an example. Other than this linear processing, the brightness reduction processor 26 can perform processing, using a lookup table based on any given preferable curve. Note, however, that, as described before, it is not so important for the brightness reduction processor 26 to precisely perform processing when the display device 1C is used under normal conditions.

In the case where the pixel values of the input image are represented by R, G, and B, the brightness reduction processor 26 may perform the above processing on each of the values of R, G, and B. Moreover, the brightness reduction processor 26 may selectively perform the above processing on any one of R, G, and B, and reduce brightness of the other colors in accordance with a reduction rate of the selected color. Such processing is preferable if a change in shade of color needs to be minimized in the low brightness region. The one color to be selected may be, for example, a predetermined one of the colors (e.g., G), or one of R, G, and B having the largest grayscale. Moreover, the brightness reduction processor 26 may transform the values of R, G and B into brightness values and chromaticity values, and perform the above processing on the brightness values.

The liquid-crystal-data generator 24 generates liquid crystal data in accordance with a processed image whose brightness of a low brightness region is lower than that of an input image, making it possible to reduce the risk that the liquid transmittance is saturated.

Hence, the display device 1C in the fifth embodiment allows the liquid crystal to achieve fine grayscale representation even if (i) power consumption is reduced and (ii) the input image is high in brightness.

Note that, in the brightness reduction processor 26, the above predetermined value of the liquid crystal transmittance to determine whether the brightness of the input image is to be decreased shall not be limited to 80%. The predetermined value may be determined as appropriate.

As described before, an object of the display devices according to the present disclosure is to reduce power consumption of the devices by generating a low brightness region, and to maximize visibility even in the low brightness region. Here, the processing performed by the BL brightness reduction processor 232 in FIG. 11 is the only processing directed to reduction in power consumption. The processing performed by the brightness reduction processor 26 contributes only to visibility, not to reduction in power consumption. Meanwhile, as described before, it is not so important to precisely present brightness of grayscale in a low brightness region. That is, the processing by the brightness reduction processor 26 may be directed only to the visibility of the low brightness region.

The brightness reduction processing described with reference to FIG. 13 involves reducing the brightness of the input image on the assumption that the upper limit of the backlight brightness in the low brightness region is 50% (i.e., the brightness of grayscale can be precisely represented if the backlight brightness is 50% or below). If the backlight brightness is lower than 50%, however, an upper limit of an input brightness to be represented by precise grayscale is also naturally low. Such a feature makes it possible to increase visibility without raising a compression ratio of the input brightness.

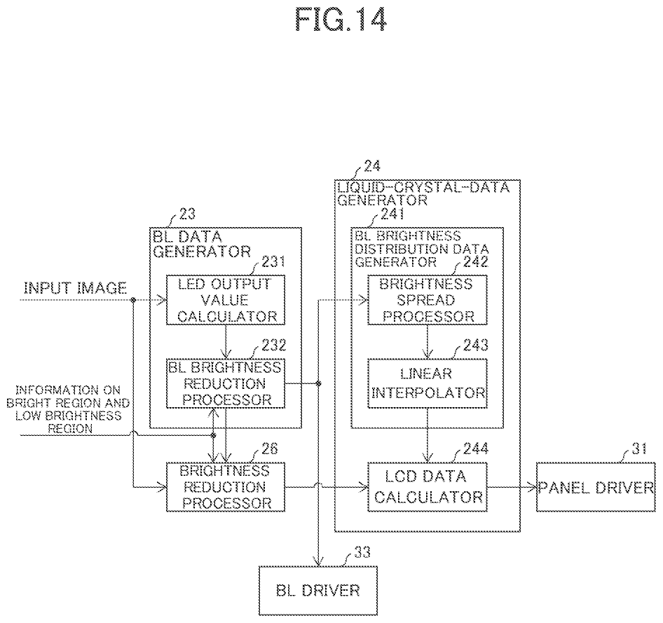

FIG. 14 is a block diagram illustrating other configurations, than those in FIG. 11, of the backlight-data generator 23, the liquid-crystal-data generator 24, and the brightness reduction processor 26 according to the fifth embodiment. In the configurations illustrated in FIG. 14, BL brightness information on a low brightness region is output from the BL brightness reduction processor 232 to the brightness reduction processor 26. Such a feature makes it possible to optimize presentation of messages while power consumption of the display device 1B is maintained low.

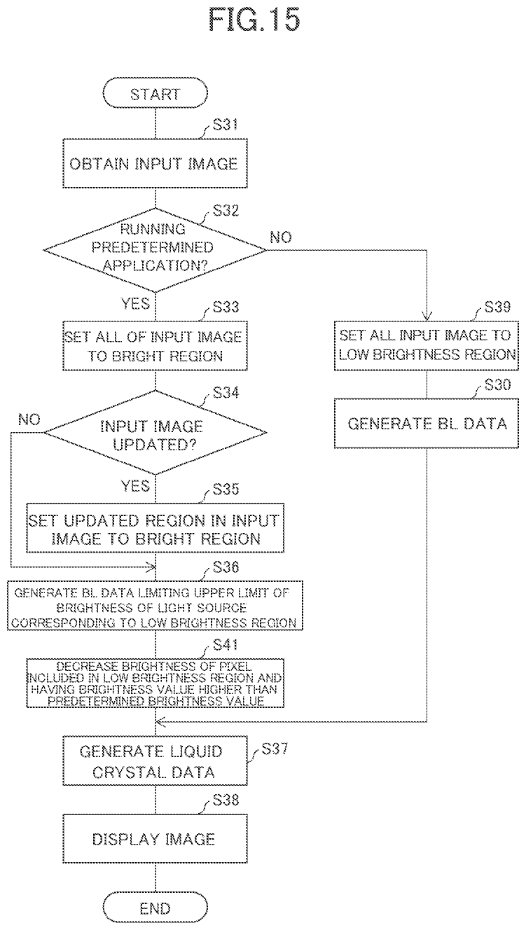

FIG. 15 is a flowchart showing processing performed by the display device 1C according to the fifth embodiment. Comparing the processing by the display device 1C in the fifth embodiment with the processing in the third embodiment, the only difference is that, in the former processing, Step S41 is performed between Steps S36 and S37.

In the display device 1C of the fifth embodiment, backlight data is generated at Step S36. After that, the brightness reduction processor 26 decreases brightness of a pixel included in the pixels of a low brightness region and having a liquid crystal transmittance higher than or equal to a predetermined rate (S41). After that, the liquid-crystal-data generator 24 generates liquid crystal data in accordance with a processed image whose brightness is decreased by the brightness reduction processor 26 (S37).

Additional Remarks

In the above embodiments, the battery 5 supplies power to the display device. This is because a battery-powered display device is strongly required to reduce power consumption and extend battery life. The technique of this present disclosure may, however, be applied to a display device powered by an external power supply. As a matter of course, such a display device can reduce power consumption, using the techniques of the present disclosure.

The present disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the present disclosure. Moreover, the technical aspects disclosed in each embodiment may be combined to achieve a new technical feature.

### CROSS REFERENCE TO RELATED APPLICATION

The present application claims priority to Japanese Patent Application No. 2018-114855, filed Jun. 15, 2018, the contents of which are incorporated herein by reference in its entirety.

Software Implementation

The main controller 2 of the display devices 1, 1A, 1B, and 1C may be implemented by logic circuits (hardware) fabricated, for example, in the form of an integrated circuit (an IC chip) and may be implemented by software run by a central processing unit (a CPU).

In the latter form of implementation, the display devices 1, 1A, 1B, and 1C include, among others: a CPU that executes instructions from programs or software by which various functions are implemented; a read-only memory (a ROM) or a like storage device (referred to as a “storage medium”) containing the programs and various data in a computer-readable (or CPU-readable) format; and a random access memory (a RAM) into which the programs are loaded. The computer (or CPU) then retrieves and runs the programs contained in the storage medium, thereby achieving the object of an aspect of the present disclosure. The storage medium may be a “non-transitory, tangible medium” such as a tape, a disc/disk, a card, a semiconductor memory, or programmable logic circuitry. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

### REFERENCE SIGNS LIST

1, 1A, 1B, 1C Display Device
3 Display
20 Display Controller (Control Device)
331 Light Source

1-11. (canceled)

12. A control device of a display device including a display including a plurality of light sources to be independently controlled,
the control device performing display processing that involves monitoring an update of an image to be displayed on a screen of the display, and causing a light source corresponding to a display region of the updated image to glow more brightly than another light source, the light source and the other light source being included in the light sources.

13. The control device according to claim 12, wherein
if detecting the update of the image when all the screen is set to a dark region, the control device performs the display processing by causing the light source corresponding to the display region of the updated image to glow more brightly than the other light source.

14. The control device according to claim 12, wherein
the control device obtains information on the update of the image from a base system of the display device or an application installed in the display device, and performs the display processing in accordance with the obtained information on the update.

15. The control device according to claim 12, wherein
if the image displayed on the screen changes in position or size depending on an input operation by a user of the display device, the control device causes a light source corresponding to the changed image to glow more brightly than another light source, the light source and the other light source being included in the light sources.

16. The control device according to claim 12, wherein
the control device causes a light source to glow more brightly than another light source, the light source corresponding to a part, of content displayed on the screen, to be newly displayed through an operation by a user of the display device, the other light source corresponding to a part, of the content, already displayed, and the light source and the other light source being included in the light sources.

17. The control device according to claim 12, wherein
the control device decreases brightness of a light source corresponding to a dark region that is a display region having brightness lower than or equal to a predetermined value, by decreasing brightness of a part, of an input image, to be displayed in the dark region, the light source being included in the light sources.

18. The control device according to claim 12, wherein
the control device decreases an upper limit of brightness of a light source corresponding to a display region having brightness lower than or equal to a predetermined value, the light source being included in the light sources.

19. A display device comprising the control device according to claim 12.

20. A control device of a display device including a display including a plurality of light sources to be independently controlled,
the control device causing a light source to glow more brightly than another light source, the light source corresponding to a display region, of the display, displaying (i) information input through an operation by a user of the display device or (ii) information related to the information input by the user, and the light source and the other light source being included in the light sources.

21. The control device according to claim 20, wherein
the control device decreases brightness of a light source corresponding to a dark region that is a display region having brightness lower than or equal to a predetermined value, by decreasing brightness of a part, of an input image, to be displayed in the dark region, the light source being included in the light sources.

22. The control device according to claim 20, wherein
the control device decreases an upper limit of brightness of a light source corresponding to a display region having brightness lower than or equal to a predetermined value, the light source being included in the light sources.

23. A display device comprising the control device according to claim 20.

24. A control method for controlling a display device including a display including a plurality of light sources to be independently controlled, the control method comprising
display processing that involves monitoring an update of an image to be displayed on a screen of the display, and causing a light source corresponding to a display region of the updated image to glow more brightly than another light source, the light source and the other light source being included in the light sources.
